(19) United States
(12) Patent Application Publication
(10) Pub. No.: US 2008/0117625 A1
(43) Pub. Date: May 22, 2008

(54) Rechargeable Object Lighting

(75) Inventor: Anne Huig den Boer, Ae Streefkerk (NL)

Correspondence Address: YOUNG & THOMPSON, 209 Madison Street, Suite 500, ALEXANDRIA, VA, 22314, US

(73) Assignee: In-Lite Design B.V., LD Nieuw-Lekkerland (NL)

(21) Appl. No.: 11/664,115

(22) PCT Filed: Sep. 30, 2005
(86) PCT No.: PCT/NL05/00708

§ 371 Date: Mar. 30, 2007

(30) Foreign Application Priority Data
Oct. 1, 2004 (NL) 1027162

(51) Int. Cl. F21S 9/02; H02J 7/02

(52) U.S. Cl. 362/183; 320/108

(57) ABSTRACT

An arrangement for lighting an object having a first, non-mobile device (1) and a second, movable device (2). The first device (1) has at least one lighting unit (3) and at least one 5 rechargeable accumulator (4). The at least one accumulator (4) is connected to the at least one lighting unit (3) in order to be able to provide this with power. The second device (2) has a charger (5) for charging the rechargeable accumulator (4) of the first device.

Devices of all types and sizes exist for lighting an object. All consist of at least one lighting unit, such as an incandescent lamp, halogen lamp, fluorescent tube or light emitting diode (LED) and a power supply which provides the lighting unit with the requisite power. The power supply can be a generator that is connected via electrical connections, such as electricity cables, to an electricity facility, such as a socket. However, the power supply can also be an accumulator that consists of one or more replaceable, optionally rechargeable, units, such as batteries.

A problem with the current types of object lighting arises in locations where there is no central electrical infrastructure, such as in woodland paths, in gardens and in remote roads. An accumulator can be used in these cases. However, the accumulator for the object lighting must be refreshed periodically, either by charging or by replacement. With known techniques part or all of the accumulator has to be removed in order to be able to replace it or, alternatively, to detach it in order to be able to charge it. However, in all cases the accumulator must be accessible from the outside. The consequence of this accessibility is that the risk of the device becoming damaged, as a consequence of, for example, moisture or vandalism, becomes greater, which results in lower reliability of the object lighting concerned.

US Patent Application US 2003/0231001 discloses a mobile charger that can be partially or completely recharged by making use of solar energy. This charger is then able to charge other portable electrical equipment via magnetic induction. The invention is employed, inter alia, in locations where there is no electrical infrastructure. However, the invention is restricted to charging of mobile devices. The charger disclosed is therefore only suitable for recharging electrical equipment such as electric toothbrushes and razors and is unsuitable for non-mobile devices, such as a non-mobile device for lighting an object.

U.S. Pat. No. 5,839,816 discloses a device in which elements which emit light are supplied with power by a rechargeable battery, which is charged by making use of one or more solar cells. This device can thus also be employed where there [symbol] disadvantage of this device is that the effectiveness of the charger, that is to say the one or more solar cells, is dependent on the number of hours of sun to which the device is exposed. Furthermore, solar cells are also liable to vandalism and covering of the cells by, for example, fallen leaves, can already result in a substantial loss in efficiency.

An aim of the invention is to be able to light an object in locations without electrical infrastructure without the accumulator having to be partially or completely removed in order to be refreshed. To achieve this, the present invention relates to an arrangement for lighting an object, comprising:
a first device for lighting an object, which is permanently bound to a fixed location, comprising at least one lighting unit and at least one rechargeable accumulator which is connected to the at least one lighting unit in order to be able to provide this with power, and
a second, movable device which comprises a charger for charging the rechargeable accumulator of the first device.

The permanent connection can be produced by using fasteners such as screws. However, it is preferred to integrate the device in the structure in which it is installed. In the case of lighting a concrete footpath, for example, the device can be embedded in the concrete. The advantage of this embodiment is that the risk of the object lighting becoming damaged by, for example, vandalism, is restricted to a minimum. The mobile second device makes it possible to charge multiple first devices using the same second device. The second device can be movable in a mobile manner, that is to say can be moved by making use of a mobile vehicle, such as a car. However, it is also possible that the second device is movable because it can be carried.

In an embodiment thereof, the first device of the arrangement comprises two contact points on one outer side, each contact point of which is connected to a pole of the rechargeable accumulator. With this arrangement the second device is equipped such that the charger can be connected to the contact points in a suitable manner. This embodiment makes it possible to use a known charger, such as a dry accumulator, for charging the rechargeable accumulator.

In a further embodiment thereof, the first device of the arra [symbol] a rectifier, such as a diode, that is installed between one of the two contact points and the pole of the rechargeable accumulator connected thereto. This rectifier, inter alia, prevents the contact points being used by unauthorised persons for tapping off power.

In an embodiment of the arrangement, the first device furthermore comprises a first coil that is connected to the rechargeable accumulator, for generating a charge current if a fluctuating magnetic field is applied, and the charger of the second device comprises a generator for generating a fluctuating, electric current and a second coil that is connected to the generator so as, if positioned in the vicinity of the first device, to generate a fluctuating magnetic field for generation of the charge current in the first device. By means of these measures the rechargeable accumulator in the first device can be charged with the aid of magnetic induction without any component of the electric circuit, of which the accumulator forms part, being accessible from the outside.

In a further embodiment thereof, the first device of the arrangement furthermore comprises a rectifier, such as a diode, which is installed between the first coil and the rechargeable accumulator. The rectifier prevents the accumulator being able to discharge via the coil.

In an embodiment of the arrangement, the first device furthermore comprises a switching element that is installed between the at least one lighting unit and the rechargeable accumulator. The switching element can, for example, be controlled by a sensor that reacts to a (radio) signal or light intensity, or to a clock, which sets a period within which the lighting unit has to function in a specific manner. The switching element can switch either between two positions, that is to say on/off, or between several positions. Because it is possible with this embodiment to switch off the object lighting if this is unnecessary or undesired, energy can be saved. As a consequence, the charging frequency, the frequency within which recharging of the rechargeable accumulator has to be carried out, can be reduced.

In all embodiments of the arrangement, the at least one lighting unit can be an LED. The use of one or more LEDs as lighting unit provides an additional possibility for lowering the charging frequency, because an LED has a low power consumption.

In all embodiments, the accumulator can be a capacitor. A capacitor can be charged relatively quickly and is not adversely affected by the so-called memory effect.

The present invention furthermore relates to a device for lighting an object, comprising:
at least one lighting unit;
a rechargeable accumulator connected to the at least one lighting unit in order to provide this with power;
   wherein the device is permanently bound to its surroundings, characterised in that the installation has two contact points on one outer side, each contact point of which is connected to a pole of the rechargeable accumulator. This device can be charged in a simple manner using well-known batteries. Furthermore, this device as well can have a rectifier and/or a switching element in the same way and for the same reasons as explained above. With this device as well the lighting unit is preferably an LED. With this device as well the accumulator can be a capacitor.

The present invention furthermore relates to a device for lighting an object, comprising:
at least one lighting unit;
a rechargeable accumulator connected to the at least one lighting unit in order to provide this with power;
   wherein the device is permanently bound to its surroundings, characterised in that the device furthermore has a coil, which is connected to the rechargeable accumulator, for generating a charge current if an oscillating magnetic field is applied. With this device the rechargeable accumulator can be charged with the aid of magnetic induction without any component of the electrical circuit, of which the accumulator forms part, being accessible from outside. Furthermore, this device as well can have a rectifier and/or a switching element in the same way and for the same reasons as explained above. With this device as well the lighting unit is preferably an LED. With this device as well the accumulator can be a capacitor.

The invention furthermore relates to a method for lighting an object in locations without an electrical infrastructure, comprising:
positioning and firmly fixing at least one first device in at least one location, the at least one first device comprising at least [symbol] rechargeable accumulator, which is connected to the at least one lighting unit in order to be able to provide this with power,
periodic charging of the rechargeable accumulator of the at least one first device with the aid of a movable second device, which comprises a charger.

This method makes it possible to charge several first devices periodically.

The invention will be explained in more detail below by way of example with the aid of the following figures. The figures are not intended to restrict the scope of the invention, but merely for illustration thereof.

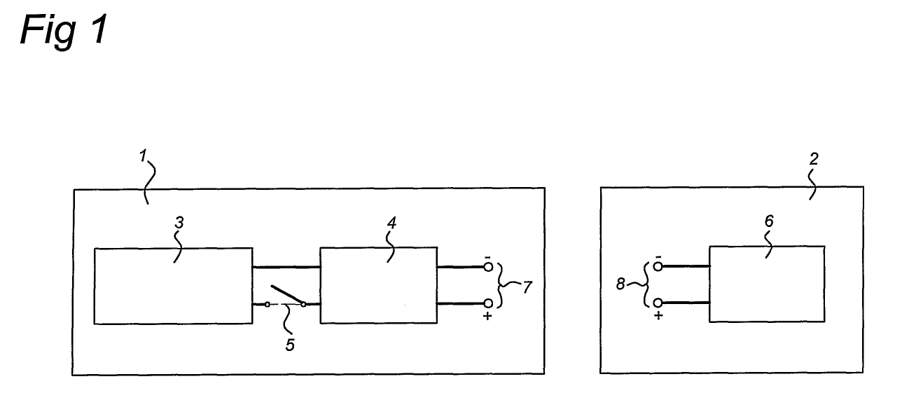

FIG. 1 shows a schematic representation of an arrangement comprising a non-mobile device for lighting an object and a charging device according to an embodiment of the present invention;

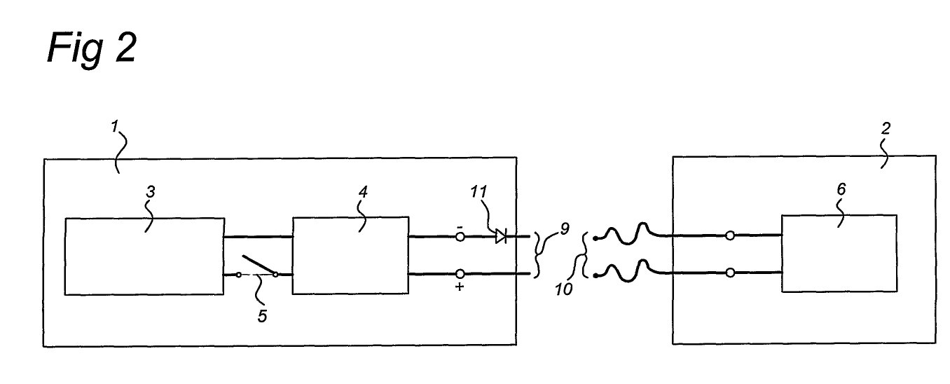

FIG. 2 shows a first embodiment of an arrangement corresponding to the present invention;

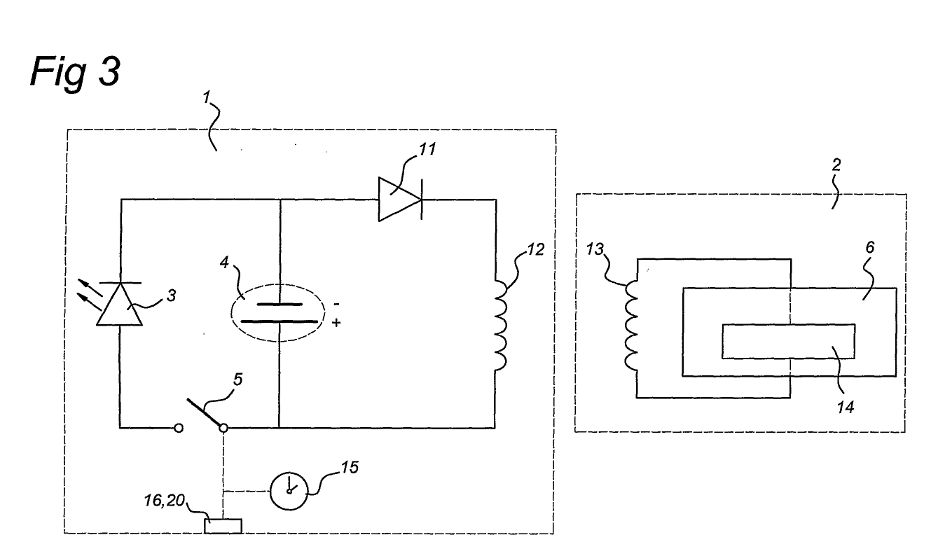

FIG. 3 shows a second embodiment of an arrangement according to the present invention.

FIG. 1 shows a schematic representation of an arrangement according to the present invention. The arrangement comprises a device 1 that is permanently bound to a fixed location for lighting an object. “Fixed” device is used here to indicate that the device is not mobile. The device 1 comprises at least one lighting unit 3 and at least one accumulator 4. Accumulator 4 applies a voltage over lighting unit 3, optionally via a switching element 5. The current that flows through lighting unit 3 as a result of the voltage applied provides for sufficient energy transfer for operation of the lighting unit 3. An external charging device 2 is needed to charge the accumulator 4. The charging device 2 in the present invention, which comprises a charger 6, can at least be moved, for example by making use of a mobile vehicle, and is preferably portable. A movable charging device 2 makes it possible to charge several devices 1 for lighting an object sequentially. A portable charging device moreover facilitates charging of devices for lighting an object that are located in locations that are difficult to reach.

In the case of sequential charging of several devices 1 it is [symbol] per device 1 is restricted to a minimum. For this reason the use of one or more capacitors as accumulator 4 is very suitable. Compared with accumulators that make use of ion transfer, such as Ni-Cad, Ni-MH and Li-on batteries, capacitors can be charged much more rapidly.

FIG. 2 shows a first embodiment of an arrangement according to the present invention. In this embodiment an electrical connection is run from the poles 7 to the outside of the fixed device 1, as a result of which two contact points 9 accessible from the outside are obtained. The charging device 2 is equipped such that electrically conducting connection entities, such as electrical cables 10, can connect the poles 8 of the charger 6 with the contact points 9 of the fixed device 1. This embodiment of the present invention makes it possible to use simple means to achieve the desired result. The charger 6 can, for example, comprise a standard dry battery. Because the contact points 9 are relatively easily accessible to unauthorised users and energy can thus be tapped off illegally, a rectifier 11, such as a diode, can be installed between the contacts 9 and poles 7. Such a rectifier 11 ensures that the current can run in one direction only, which in this case corresponds to the charging direction.

FIG. 3 shows a second embodiment of an arrangement according to the present invention. In this arrangement the poles 7 of the at least one accumulator 4 are connected to a coil 12 inside the fixed device 1, and the poles 8 of the charger 6 are connected to a coil 13. The charger 6 comprises a generator 14 for generating a fluctuating electrical current, such as an alternating current. In this embodiment charging of the at least one accumulator 4 is effected by making use of the principle of magnetic induction.

In the charging device 2 an alternating magnetic field is generated with the alternating current generated in the charger 6, which flows through a coil 13. It must be understood that it is also possible to use other fluctuating currents known to those skilled in the art, such as a periodically interrupted current. The fluctuating magnetic field, which is formed by the coil 13, influences coil 12. As a consequence of the fluctuating magnetic field an alternating current also flows through coil 12. Accumulator 4 can be charged with the aid of this alternating current. With this embodiment as well the charger 6 can comprise a dry battery.

To prevent discharge of the accumulator 4 via coil 12 a rectifier, such as a diode 11, can be installed in a suitable manner between the accumulator 4 and coil 12.

The primary coil 13 and secondary coil 12 used in this induction transfer can be optimised in terms of properties by varying the number of windings, the orientation of the two coils, the magnitude and frequency of the fluctuating current, etc. Good matching of the two coils 12, 13 to one another ensures an efficient transfer of energy, which results in a faster charge time and less loss of power during charging.

Because the majority of devices for lighting an object have to be operational only during a portion of the day, it is possible in both embodiments, shown in FIG. 2 and FIG. 3, respectively, to install a switching element 5 in the circuit that comprises the lighting unit 3 and the accumulator 4. The switching element 5 can, for example, be connected to a clock 15 or to a sensor. The sensor can be a light sensor 16, that is to say a sensor that detects the intensity of the illumination of the object without use of the device. In this way the device can be active within a predetermined period or, alternatively, in the case of too low an illumination of the object by, for example, the sun. The sensor can also be a radio (RF) sensor 20. With the aid of this RF sensor 20 lighting unit 3 can be switched on or off or adjusted in terms of light intensity, with the aid of an RF control signal transmitted remotely.

The switching element 5 can switch either between two positions, that is to say on/off, or between several positions. In the latter case the loading on the lighting unit 3 can be adjusted in response to the degree in which lighting is needed. For instance, it is possible that, based on signals from light sensor 16, lighting unit 3 is on at a lower power during the hours of dusk than when it is completely dark, for example around midnight when there is a new moon.

A device 1 provided with the elements from one of the embodiments, as explained above, takes up relatively little space and can therefore be integrated in a relatively simple manner in or on a suitable structure in a manner known to those skilled in the art without the device 1 being able to be removed in a simple manner. The whole [symbol] in concrete so as then to be installed in a wall or path. It is likewise also possible to place the device inside a lamppost for installation, so that after installation it is no longer easily accessible to moisture and/or vandals.

As stated above, it is desirable to charge the accumulator 4 within a limited period, in some cases of the order of minutes. Rechargeable batteries, such as Ni-Cad, Ni-MH and Li-on batteries, however need time to charge. Furthermore, Ni-Cad and Ni-MH batteries are also adversely affected by the so-called memory effect. To counteract the memory effect the battery must first be completely empty before it can be charged again. A suitable accumulator 4 which can be charged rapidly and, moreover, is not adversely affected by a memory effect, is a capacitor. The capacitor will have to have a sufficiently high capacity in order to be able to function for a prolonged period without recharging.

It is also desirable that the frequency at which the accumulator 4 is charged is not too high. Apart from diode 11 and switch 5, which prevent discharge of the accumulator 4 and unnecessary use of the at least one lighting unit 3, respectively, the charging frequency of the accumulator 4 can be restricted by using lighting units 3 for the at least one lighting unit 3 that give sufficient light but nevertheless have a low power consumption. A suitable lighting unit 3 for the present invention is an LED.

A few examples quoting figures are given below to provide even better understanding of the invention.

### EXAMPLE 1

In this example the device for lighting an object comprises one LED and the accumulator comprises at least one rechargeable penlite battery. The LED has a power consumption of 64 mW at a voltage of 3.2 V and a current of 20 mA. One penlite battery has a capacity of 2200 mA and provides a voltage of 1.2 V. The desired charging frequency for the accumulator 4 is set at once per month. Furthermore, the LED has to be on for only 10 hours per day. In this example three penlite batteries are needed to provide the LED with the requisite voltage. Because, in the above case, it must be possible to supply 6083 mA in one month, three penlite batteries are also needed for the requisite capacity. The device thus comprises one LED and 3 penlite batteries, which together form the accumulator.

### EXAMPLE 2

In this example the same type of LED and the [symbol] used as in Example 1. There is still only one LED used. In contrast to the previous example, the desired charging frequency is halved, that is to say six times per year. An accumulator that comprises three penlite batteries is still sufficient to supply the requisite voltage. However, because the charging frequency has been halved, twice the capacity, i.e. 12167 mA, must be available. Six penlite batteries are thus needed in order to achieve this. These can be distributed between two different accumulator units, each with three batteries.

Both examples relate to the use of one LED. However, it is highly probable that in many embodiments more than one LED is used. Depending on the requirements in terms of light intensity, power dissipation and volume, an optimum circuit of LEDs or other suitable lighting units can be obtained.

In addition, in both examples use is made of penlite batteries as accumulator 4. As already put forward above, it is, however, also possible to use one or more capacitors as accumulator. The capacity of these one or more capacitors will have to be sufficient to achieve a charging frequency of once per month or once every two months. Such a capacity can soon amount to more than 500 F. In order not to have to top up the charge too quickly, use can, of course, be made of known techniques with regard to solar cells in order to prevent at least partial discharge during non-use of the capacitors. On a very sunny day such a solar cell would even be able to charge the capacitors partially. With such an application one or more solar cells can be integrated in the device 1 in such a way that they are protected against external influences, such as traffic and vandalism.

1. Arrangement for lighting an object, comprising:
a first device (1) for lighting an object, which is permanently bound to a fixed location, comprising at least one lighting unit (3) and at least one rechargeable accumulator (4) which is connected to the at least one lighting unit (3) in order to be able to provide this with power, and
a second, movable device (2) which comprises a charger (6) for charging the rechargeable accumulator (4) of the first device.

2. Arrangement according to claim 1, wherein the first device comprises two contact points (9) on one outer side, each contact point (9) of which is connected to a different pole (7) of the at least one rechargeable accumulator and wherein the second device is equipped to connect the charger (6) to the contact points (9) in a suitable manner.

3. Arrangement according to claim 2, wherein the first device furthermore comprises a rectifier (11) that is installed between one of the two contact points (9) and the pole (7) of the rechargeable accumulator (4) connected thereto.

4. Arrangement according to claim 1, wherein the first device (1) furthermore comprises a first coil (12) that is connected to the rechargeable accumulator (4), for generating a charge current if a fluctuating magnetic field is applied, and the charger (6) of the second device (2) has a generator (14) for generating a fluctuating, electric current and the second device (2) furthermore has a second coil (13) that is connected to the generator (14) so as, if positioned in the vicinity of the first device (1), to generate a fluctuating magnetic field for generation of the charge current in the first device (1).

5. Arrangement according to claim 4, wherein the first device (1) furthermore comprises a rectifier (11) which is installed between the coil (12) and the rechargeable accumulator (4).

6. Arrangement according to claim 1, wherein the first device (1) furthermore comprises a switching element (5) that is installed between the at least one lighting unit (3) and the at least one rechargeable accumulator (4).

7. Arrangement according to claim 6, wherein the switching element (5) is connected to at least one element from a group comprising a sensor (16, 20) and a clock (15).

8. Arrangement according to claim 1, wherein the at least one lighting unit (3) is a light emitting diode (LED).

9. Arrangement according to claim 1, wherein the at least one rechargeable accumulator (4) is a capacitor.

10. Device for lighting an object, comprising:
at least one lighting unit (3);
at least one rechargeable accumulator (4) connected to the at least one lighting unit (3) in order to provide this with power;
characterised in that the device is permanently bound to its surroundings.

11. Device according to claim 10, wherein the installation comprises two contact points (9) on one outer side, each contact point (9) of which is connected to a pole (7) of the at least one rechargeable accumulator (4).

12. Device according to claim 11, wherein the device furthermore comprises a rectifier (11), which is installed between one of the two contact points (9) and the pole (7) of the at least one rechargeable accumulator (4) connected thereto.

13. Device according to claim 10, wherein the device furthermore comprises a coil (12), which is connected to the at least one rechargeable accumulator (4), for generating a charge current if a fluctuating magnetic field is applied.

14. Device according to claim 13, wherein the device furthermore comprises a rectifier (11), which is installed between the coil (12) and the at least one rechargeable accumulator (4).

15. Device according to claim 10, wherein the device furthermore comprises a switching element (5), which is installed between the at least one lighting unit (3) and the at least one rechargeable accumulator (4).

16. Device according to claim 15, wherein the switching element (5) is connected to at least one element from a group comprising a sensor (16, 20) and a clock (15).

17. Device according claim 10, wherein the at least one lighting unit (3) is a light emitting diode (LED).

18. Method for lighting an object in locations without an electrical infrastructure, comprising:
positioning and firmly fixing at least one first device (1) in at least one location, the at least one first device (1) comprising at least one lighting unit (3) and at least one rechargeable accumulator (4), which is connected to the at least one lighting unit (3) in order to be able to provide this with power,
periodic charging of the rechargeable accumulator (4) of the at least one first device (1) with the aid of a movable second device (2), which comprises a charger (6).
